(19) United States
(12) Patent Application Publication
(10) Pub. No.: US 2014/0257931 A1
(43) Pub. Date: Sep. 11, 2014

(54) USER INTERFACE FOR A MARKET POLLING AND RESEARCH SYSTEM

(71) Applicant: 1Q, LLC, Atlanta, GA (US)

(72) Inventor: Keith Rinzler, Atlanta, GA (US)

(73) Assignee: 1Q, LLC, Atlanta, GA (US)

(21) Appl. No.: 14/285,803

(22) Filed: May 23, 2014

Related U.S. Application Data
(63) Continuation-in-part of application No. 13/781,744, filed on Feb. 28, 2013.

(51) Int. Cl. G06Q 30/02

(52) U.S. Cl. CPC G06Q 30/0203
USPC 705/7.32

(57) ABSTRACT

The invention may be embodied in a user interface for a dynamic market polling and research system that receives poll definitions and displays real-time progress information and poll results in concise at-a-glance formats. The user interface makes the system intuitively easy non-trained personnel to use, both as poll designers and as poll respondents. The at-a-glance user interface screens for poll participants allows the respondents to easily enroll as pay-per-response participants and to easily answer multiple-choice poll questions on mobile phones and other common user communication devices. The at-a-glance user interface screens for poll designers allow the designers to easily define polls, monitor results in real-time, and view the results on geographic and demographic bases. Taken together, the highly intuitive, easy-to-use, and easy-to-understand poll designer and poll participant user interface screens enable broad enrollment and participation by a much wider audience that conventional polling and market research systems.

### REFERENCE TO RELATED APPLICATION

This application is a continuation-in-part of commonly owned, currently pending U.S. patent application Ser. No. 13/781,744 filed Mar. 2, 2013, which is incorporated by reference.

### TECHNICAL FIELD

The present invention relates to electronic data collection systems and, more particularly, to a user interface for a dynamic market polling and research system that receives poll definitions and displays real-time progress information and poll results in concise at-a-glance formats.

### BACKGROUND

Direct marketing is a $150+ billion industry, while market research and polling account for another $40+ billion each year. Increasing use of online commerce and social media creates new opportunities and presents new challenges for direct marketing and market research. Cost effective direct marketing and market research requires effective and efficient techniques for identifying the most appropriate target audience each particular direct communication project and ensuring that the direct communication recipients actually read the polling or marketing information delivered to them. Properly identifying and motivating the target audience is often more important, and expensive, than locating raw address data to work with. While social media has experienced tremendous growth and contains a wealth of information concerning potential target audiences, direct marketing systems have not been developed to leverage this resource to advance market research and polling objectives.

Effective advertising and market research continue to be the keystones of a successful business. Despite continuing efforts to utilize online resources effectively, prior approaches to online market research and polling have been highly inaccurate with cost-prohibitive technical barriers preventing more accurate results. In addition, prior attempts to incorporate online resources into advertising have experienced very poor click-through and response rates. Existing technology for incorporating social media into market research and polling remains cumbersome and inaccurate. As a result, the current lack of affordable and effective direct marketing and research platforms presents a major barrier to entry for many companies, especially small and medium-sized businesses, which cannot afford to expend the vast sums necessary to reach their target audiences.

Conventional market polling systems typically utilize cumbersome batch-mode formats for defining poll parameters and only present the results after-the-fact in dense reports that are often difficult understand. These factors make it difficult for non-specialized users to use and understand the systems. As a result, conventional polling and market research systems are generally designed for and used by professional users and consultants.

There is, therefore, a continuing need for improved online market research and polling systems and, more specifically, market research and polling systems with user interfaces that are easier to use and understand.

### SUMMARY

The present invention meets the needs described above in a user interface for a dynamic market polling and research system that receives poll definitions and displays real-time progress information and poll results in concise at-a-glance formats. The user interface makes the system intuitively easy non-trained personnel to use, both as poll designers and as poll respondents. The at-a-glance user interface screens for poll participants allows the respondents to easily enroll as pay-per-response participants and to easily answer multiple-choice poll questions on mobile phones and other common user communication devices. The at-a-glance user interface screens for poll designers allow the designers to easily define polls, monitor results in real-time, and view the results on geographic and demographic bases. Taken together, the highly intuitive, easy-to-use, and easy-to-understand poll designer and poll participant user interface screens enable broad enrollment and participation by a much wider audience that conventional polling and market research systems.

The system may be embodied in a computer system, method, or computer product configured for implementing a dynamic permission-based market polling and research system. In a particular embodiment, a menu-driven respondent registration utility receives demographic information from users registering as poll respondents. The respondent registration utility computes and displays an earning potential indicator that increases with increasing demographic information received from a registering user to encourage the registering user to enter complete demographic information. The market polling and research system uses the demographic information to qualify registered respondents to participate in polls in exchange for poll response compensation. The market polling and research may pay the poll response compensation on a per-response basis.

The menu-driven respondent registration may include a menu-driven respondent designation utility operable for receiving a designation of a charitable organization to receive a designating respondent's poll response compensation. The market polling and research system then pays the designating respondent's poll response compensation to the designated charitable organization. A charitable organization selection menu may be display a predefined list of charitable organizations allowing the designation to be entered by selection from the list.

The menu-driven respondent registration utility may also include a verification code utility that send a verification code to a registering respondent by a communication mode separate from the menu-driven respondent registration utility. The verification code utility receives the verification code and complete registration of the registering respondent upon receipt of the verification code into the verification code utility. The market polling and research system of may also include a downloadable mobile app configured to allow registered respondents to receive poll questions and submit poll responses from mobile communication devices.

A menu-driven poll definition utility receives poll definitions from poll designers. The market polling and research system communicate polls in accordance with the poll definitions to a plurality of registered respondents, receives poll responses, and display the poll responses. The poll definition utility displays a top-level panel including control items corresponding to a three-step process for designing a poll. A first poll definition panel receives a poll question, a second poll definition panel receives demographic criteria of qualified respondents, and a third poll definition panel receives ending criteria for the poll.

The first poll definition panel may also include control items for selecting among a plurality of predefined question formats and, upon user selection of a question format, expand to display a semi-structured panel receiving user entry defining contents of a poll question in the selected question format. The second poll definition panel may include a first control item for selecting a demographic definition of qualified poll recipients and a second control item for selecting a geographic definition for the poll. The third poll definition panel may include a semi-structured panel for entering a maximum number of poll responses and a maximum poll time.

An in-process poll result reporting utility computes, displays and continually updates in-process poll results as a poll progresses. The in-process poll results may include a chart depicting overall poll results and a map indicating locations of poll results and one or more demographic split charts depicting percentages of poll results received by respondents in demographic categories. Similarly, a completed poll result reporting utility compute and displays final poll results that may include a chart depicting overall poll results, a map indicating locations of poll results, and one or more demographic split charts depicting percentages of poll results received by respondents in demographic categories.

In view of the foregoing, it will be appreciated that the present invention provides an improved user interface for a market polling and research system. The specific systems and techniques for accomplishing the advantages described above will become apparent from the following detailed description of the embodiments and the appended drawings and claims.

### BRIEF DESCRIPTION OF THE DRAWINGS

FIG. 1 depicts a user interface screen for an illustrative dynamic polling and market research system (“1Q system”) where poll designers and poll respondents enter the 1Q system with a poll respondent control item selected.

FIG. 2 depicts a user interface screen where the IQ system receives respondent registration information.

FIG. 3 depicts a user interface screen where the IQ system receives additional respondent registration information and displays an earning potential indicator to encourage respondents to provide requested registration information used to select respondents for poll participation.

FIG. 4 depicts a user interface screen where the IQ system receives a charitable organization selection to receive respondent compensation.

FIG. 5 depicts a user interface screen where the IQ system confirms a charitable organization selection to receive respondent compensation.

FIG. 6 depicts a user interface screen where the IQ system updates the displayed earning potential indicator based on participant completion of requested registration information.

FIG. 7 depicts a user interface screen where the IQ system advises a registering respondent of a verification code sent to the respondent by text message using the registration information provided by the respondent.

FIG. 8 depicts a user interface screen where the IQ system confirms registration of the respondent after receipt of the verification code from the respondent.

FIG. 9 depicts a user interface screen where the IQ system downloads a mobile device app allowing respondents to answer poll questions from mobile communication devices.

FIG. 10 depicts a user interface screen where poll designers and poll respondents enter the 1Q system with a poll designer control item selected.

FIG. 11 depicts a top-level poll design panel displayed by the 1Q system.

FIG. 12 depicts the poll design menu displayed by the 1Q system with a first poll definition menu displayed.

FIG. 13 depicts the poll design menu displayed by the 1Q system with a second poll definition menu displayed.

FIG. 14 depicts the poll design menu displayed by the 1Q system with certain selections entered into the second poll definition menu.

FIG. 15 depicts the poll design menu displayed by the 1Q system with a third poll definition menu displayed.

FIG. 16 depicts the poll design menu displayed by the 1Q system with example poll ending criteria entered.

FIG. 17 depicts the poll design menu displayed by the 1Q system with a poll geographic criteria menu displayed.

FIG. 18 depicts the poll design menu displayed by the 1Q system with an example poll defined by poll designer menu entries.

FIG. 19 depicts the poll confirmation panel displayed by the 1Q system confirming the example poll and providing a cost quote for the poll.

FIG. 20 depicts a payment panel displayed by the 1Q system for charging the poll designer for the example poll.

FIG. 21 depicts a dynamic in-process poll results screen displayed by the 1Q system for the poll designer prior to receipt of poll results.

FIG. 22 depicts the dynamic in-process poll results screen displayed by the 1Q system for the poll designer showing receipt of partial poll results while the poll is in progress.

FIG. 23 depicts demographic split panels displayed by the 1Q system as part of the in-process poll results screen.

FIG. 24 depicts an enlarged view of the main poll results displayed as a pie chart with a corresponding map showing the locations of the respondents.

FIG. 25 depicts selected demographic split panels displayed as bar charts by the 1Q system.

FIG. 26 depicts a poll closing refund screen displayed by the 1Q system for an example poll that timed out prior to receiving the maximum number of responses.

FIG. 27 depicts a completed poll results screen displayed by the 1Q system upon completion of the example poll.

### DETAILED DESCRIPTION OF THE EMBODIMENTS

The present invention may be embodied as a menu-driven user interface system for a compensation driven permission marketing and polling system. A particular example of this type of system as known as the “1Q system” is described in U.S. patent application Ser. No. 13/781,744 entitled “Dynamic Polling and Market Research System” filed Feb. 28, 2013; which claims priority to U.S. Provisional Patent Application Ser. No. 61/604,988 entitled “Systems and Methods for Collecting Marketing and Polling Data,” filed Feb. 29, 2012, which are both incorporated by reference. It will be understood that the 1Q system is described as an illustrative, preferred embodiment of the invention. The innovative user displays apply to polling and market research systems generally. The invention as defined by the claims should not be construed as limited to the specific 1Q system embodiment used as an illustrative example.

The 1Q system is a compensation driven permission marketing and polling system that utilizes per-response member survey compensation, social media interfacing, and dynamic polling to produce desired demographic results with the minimum number of member requests. Poll designers (also referred to as customers of the 1Q system) are those presenting or asking poll questions (also referred to as surveys), whereas poll respondents (also referred to as members of the 1Q system or participants) are those answering or responding to the poll questions. While the 1Q system may be used for a wide range of objectives, such as direct marketing, market research surveys, political polling, focus groups, and any other marketing or research objective relying on bulk responses to direct member communications, the description of system refers to a member survey (also called polling) example as an illustrative application of the technology. It will be appreciated that the 1Q system can be readily adapted to other direct response objectives by changing the content of the member communications.

Use of the 1Q system by poll designers and poll respondents is facilitated and encouraged by a user-friendly, menu-driven user interface system implemented by the 1Q system and typically accessed by remotely located users utilizing conventional browsers over Internet connections. Thus any user with a browser and an Internet connection may participate as a poll designer and/or poll respondent, although prior registration is typically required at least for poll respondents. A specific example of the user interface technology is further described below with reference to the appended figures, in which an example survey (also referred to as a poll) is described as an illustrative example of the technology. Direct response sales, focus groups, political polls, and other direct response objectives may also be accomplished as a matter of design choice.

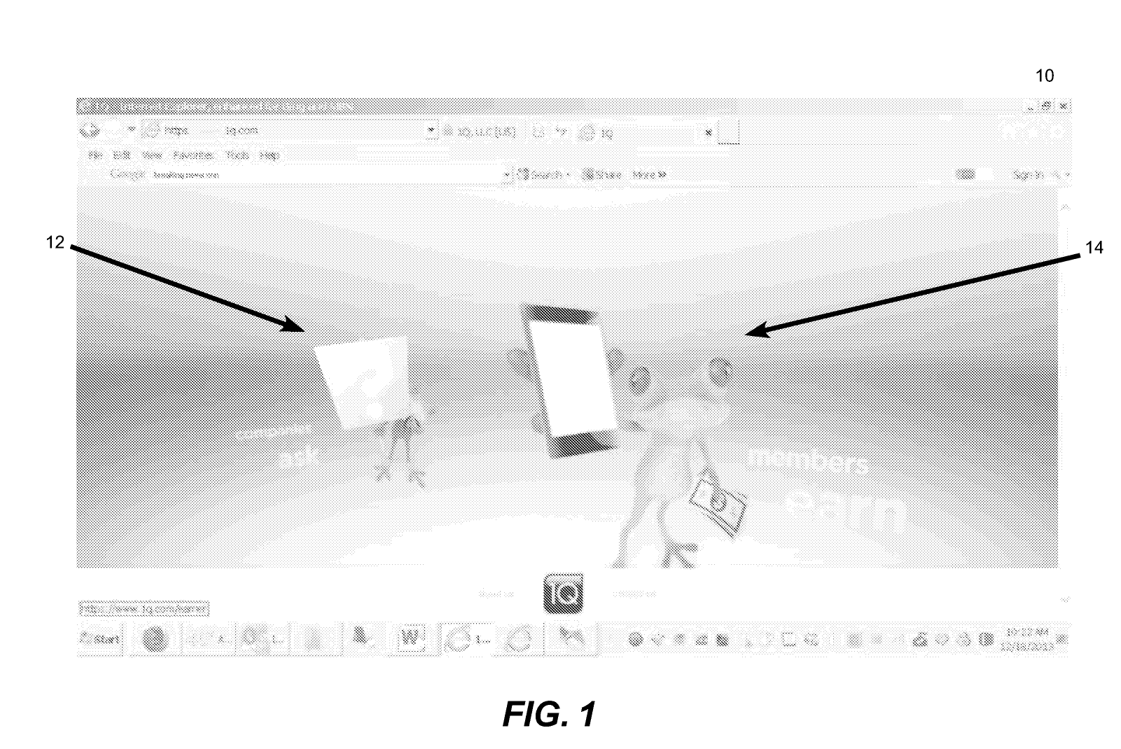

FIG. 1 depicts a user interface screen 10 for the illustrative 1Q system where poll designers and poll respondents enter the 1Q system. The interface screen 10 includes a poll participant control item 12 and a poll respondent control item 14 with the poll respondent control item selected. The selected control item increases in size upon selection to show the user which control item has been selected. FIGS. 1-9 illustrate additional user interface screens utilized for respondent enrollment as potential poll participants in the 1Q system.

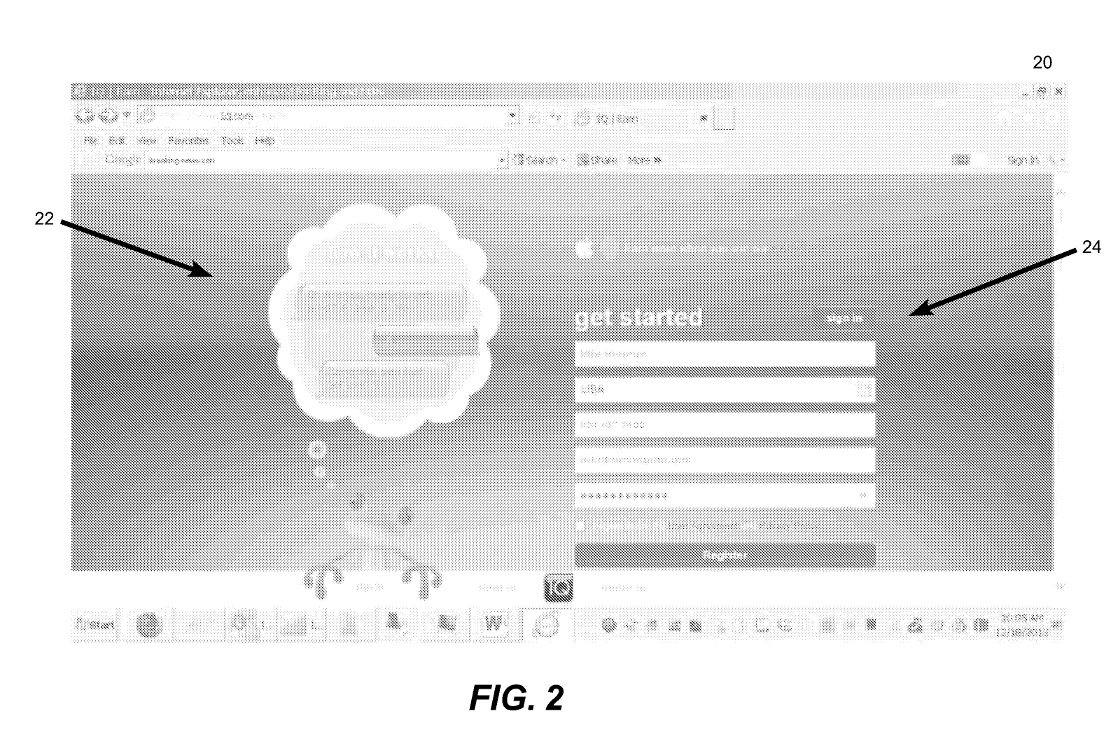

FIG. 2 depicts a user interface screen 20 where the IQ system receives basic respondent registration information. This screen displays instructional information 22 and a semi-structured menu 24 for receiving registration information from a registering respondent. This particular screen receives name, contact, user identification and password information entered by the registering respondent. The respondent is agrees to the 1Q terms and conditions before proceeding with further registration.

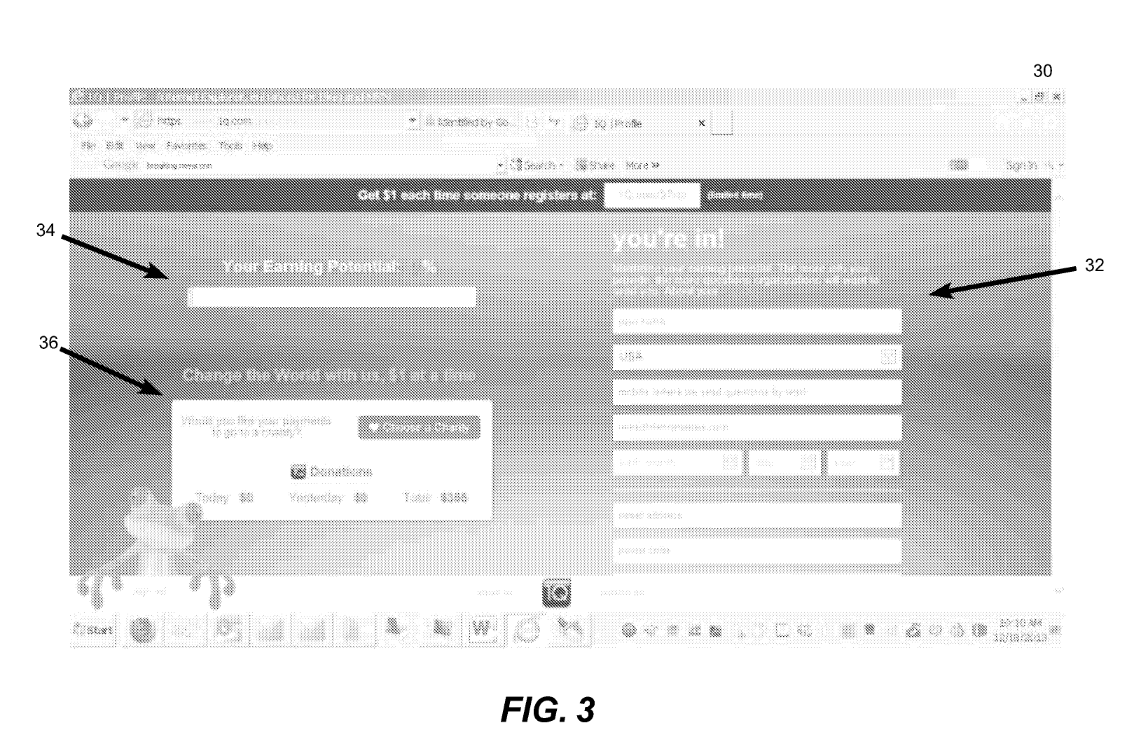

FIG. 3 depicts a user interface screen 30 displaying a semi-structured panel 32 for receiving additional respondent registration information, such as demographic information including birthday that's can be used for age-based poll qualification and a physical address that can be used for geographic poll qualification. The respondent may be encouraged to enter additional demographic information for poll qualification, such as race, educational level, field of employment, number of children in household, membership in organizations, political affiliation, religious affiliation, type of vehicle owned, recent products purchased, products planned for purchase in the near future, types of recreation, dietary habits, health concerns, preferred soft drinks, areas of training, areas of interest, and so forth. The user interface screen 30 also displays an earning potential indicator 32 to encourage respondents to provide requested registration information used to select respondents for poll participation.

Detailed demographic information allows poll designers to hone in on specific demographic groups (e.g., tennis players, persons over 60, teenagers, etc.) in specific polls, which benefits both poll designers and poll respondents by supporting well targeted polls. The 1Q system is therefore encourages respondents to enter high level of demographic information that can be used for poll qualification. The earning potential indicator 32 is an intuitive, at-a-glance user interface technique designed to provide the registering respondent an indication of the number of polls the respondent is likely to be selected for based on the amount of demographic information provided. Since respondents typically enroll to receive compensation, the earning potential indicator 32 increases with higher levels of demographic information as a way to encourage the entry of detailed demographic information.

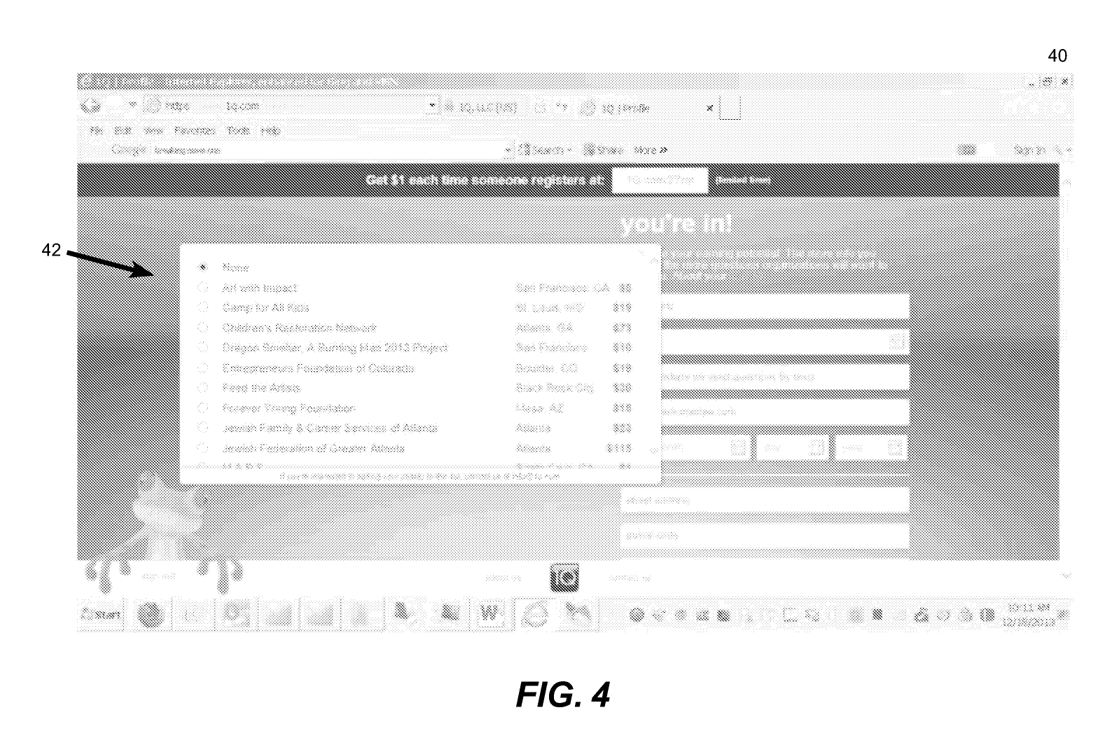

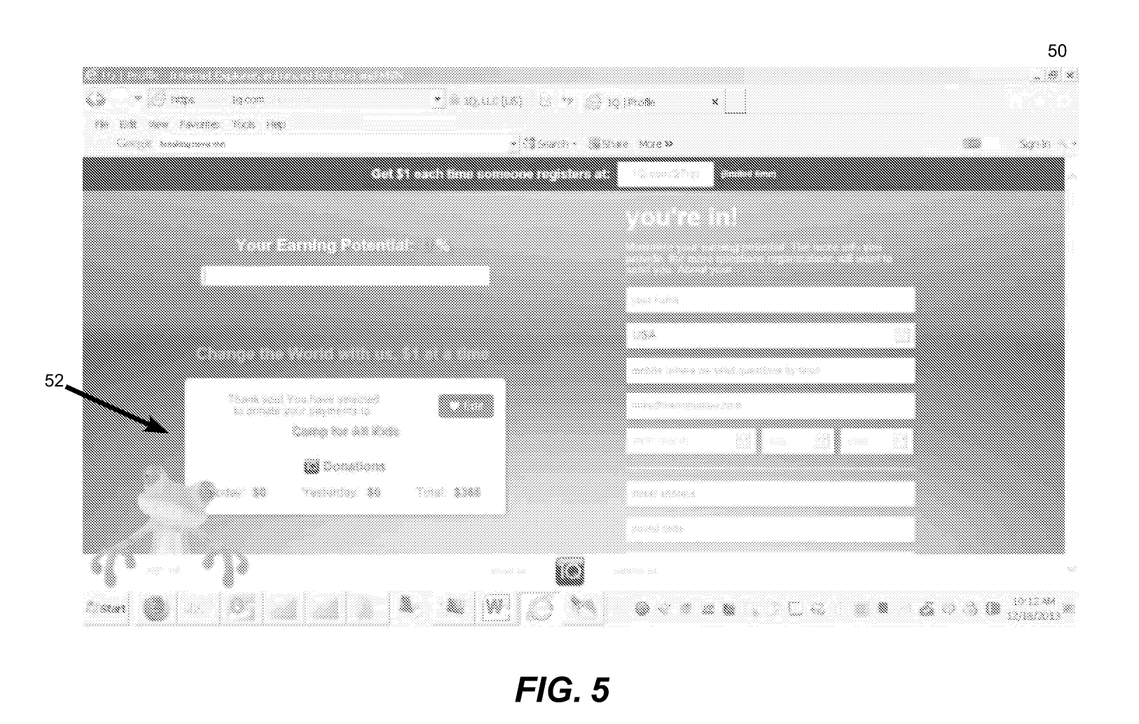

The user interface screen 30 also displays a charitable organization selection item 34 allowing the registering respondent to select a charity to receive the respondent's poll compensation. The display item 34 shows how much 1Q has donated on behalf of respondents to charity through poll compensation and allows the user to select a control item to activate a menu for selecting a charitable organization to receive the respondent's poll compensation. The screen may also show how much a particular respondent has donated to charity through poll contributions. FIG. 4 depicts the user interface screen 40 displaying a menu 42 where the IQ system receives a charitable organization selection to receive the respondent's poll compensation. The menu 42 also shows how much 1Q has donated on behalf of respondents to each charity through poll compensation. The screen may also show how much a particular respondent has donated to each charity through poll contributions. FIG. 5 depicts a user interface screen 50 showing a control item 52 where the IQ system confirms a charitable organization selection to receive respondent compensation.

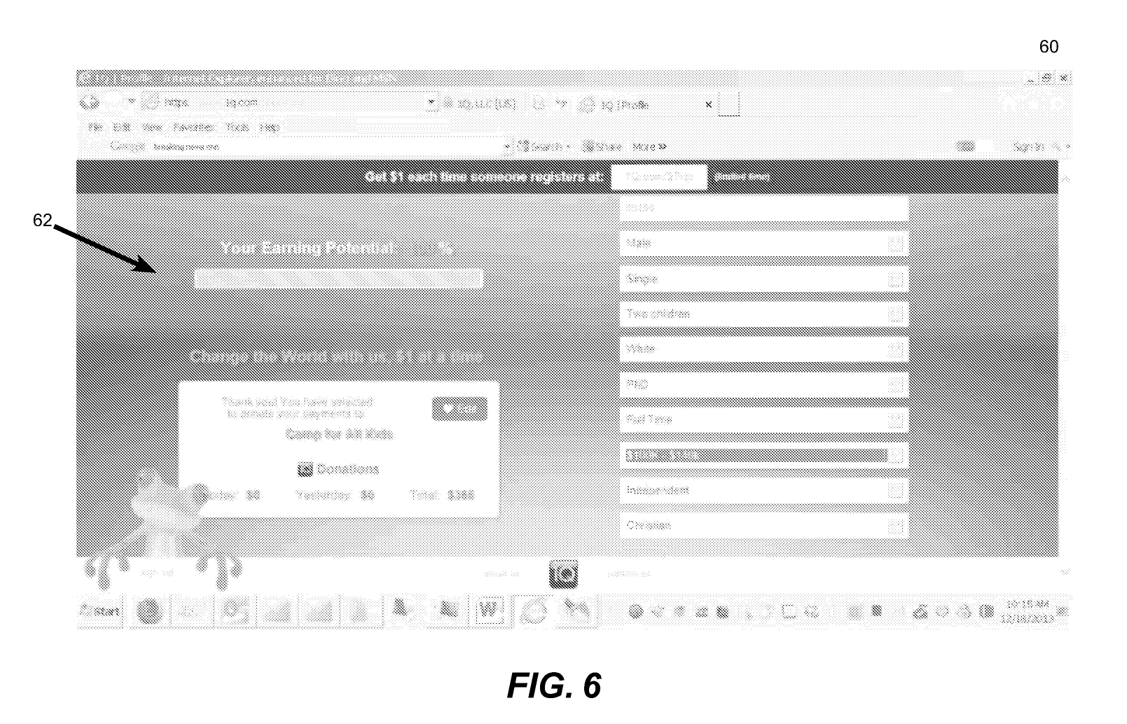

FIG. 6 depicts a user interface screen 60 where the IQ system shows an updated earning potential indicator 62 based on participant completion of requested registration information. In this example, the demographic information entered to achieve a 100% earning potential indication (birth date was previously entered) includes geographic indicator (zip code), sex, marital status, number of children, race, education level, income category, political affiliation, and religious affiliation.

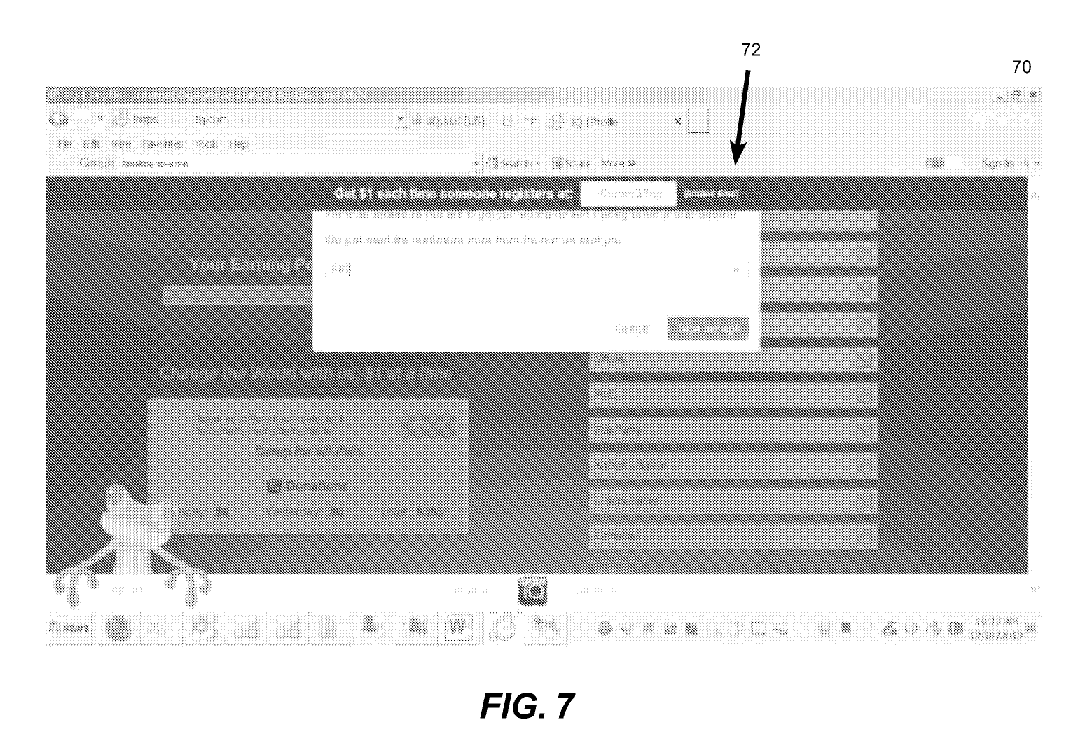

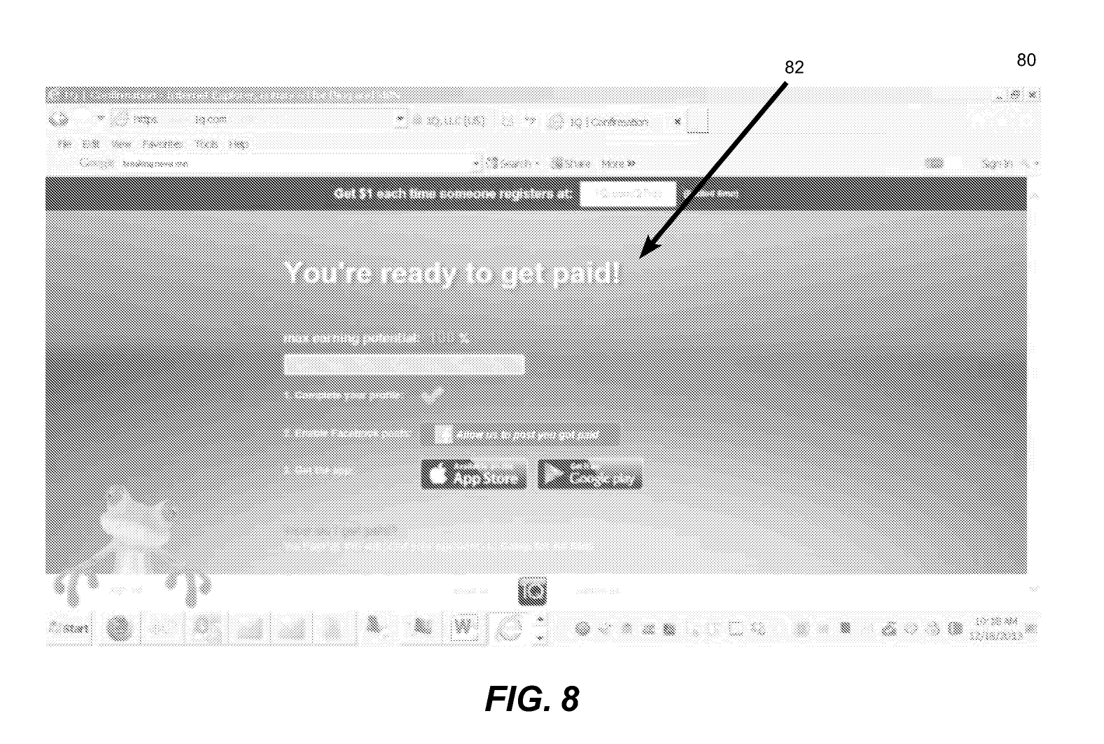

FIG. 7 depicts a user interface screen 70 including a verification code panel 72 where the IQ system advises a registering respondent of a verification code sent to the respondent by text message using the registration information provided by the respondent. FIG. 8 depicts a user interface screen 80 including a registration confirmation panel 82 (in the example, “You're Ready To Get Paid!) where the IQ system confirms registration of the respondent after receipt of the verification code from the respondent.

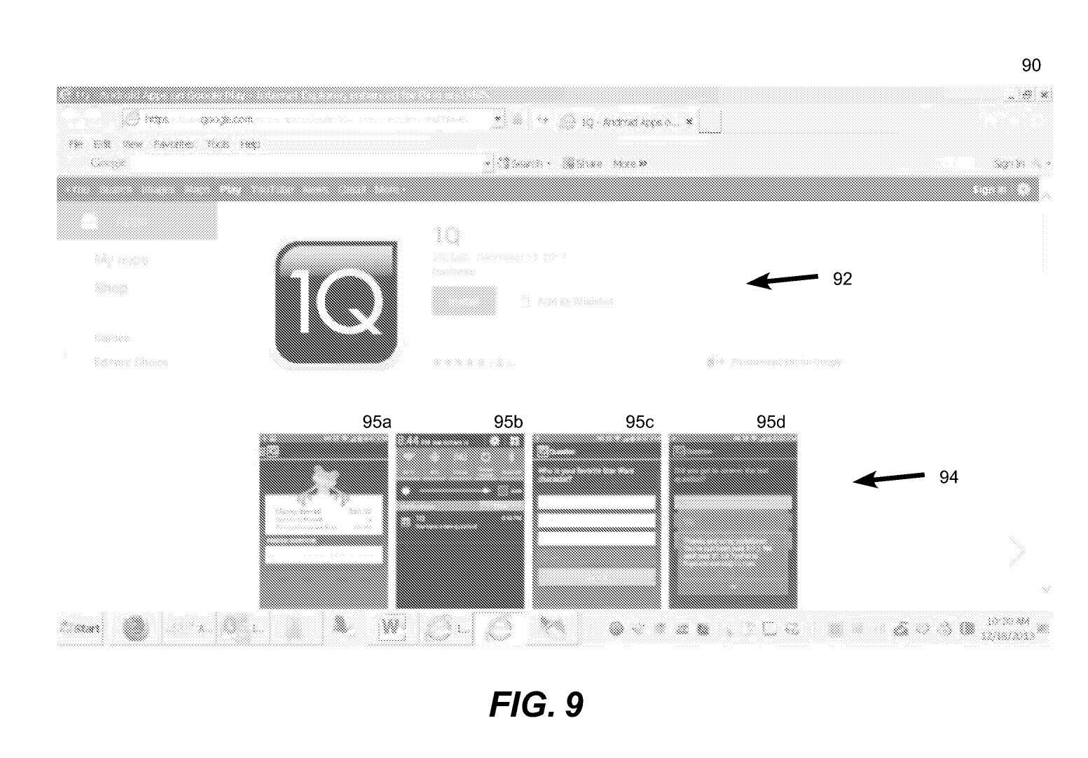

FIG. 9 depicts a user interface screen 90 where the user selects a mobile app and IQ system downloads the selected mobile device app allowing respondents to answer poll questions from mobile communication devices. The user interface screen 90 also displays several example mobile device screens 94 that the 1Q system uses to interact with a respondent via their mobile device. A first example mobile app screen 95a shows the respondent how much the respondent has earned in poll compensation, how many poll questions they missed (failed to respond to before the poll closed), and their average response time. A second mobile app screen 95b advises the respondent that an active poll question has been received. A third mobile app screen 95c displays the poll question on a single display (at-a-glance format) and allows the respondent to submit a response. A fourth mobile app screen 95d displays confirmation of a poll response while the poll was still active, confirmation of poll compensation, and indication where the compensation will be deposited.

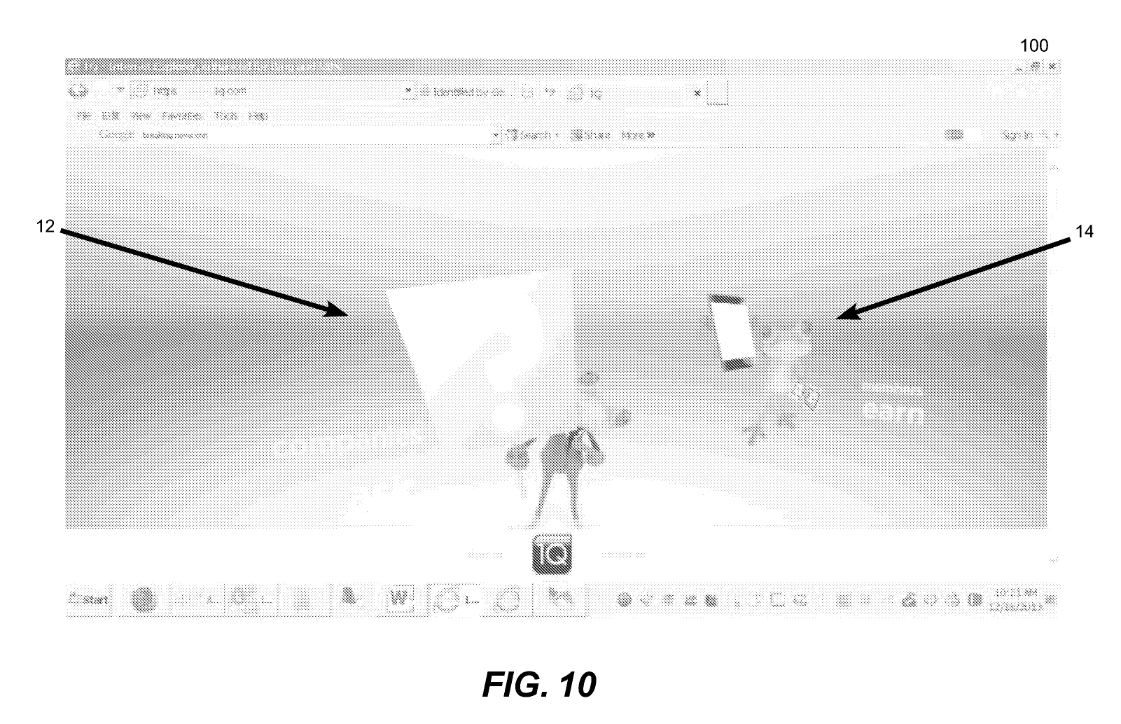

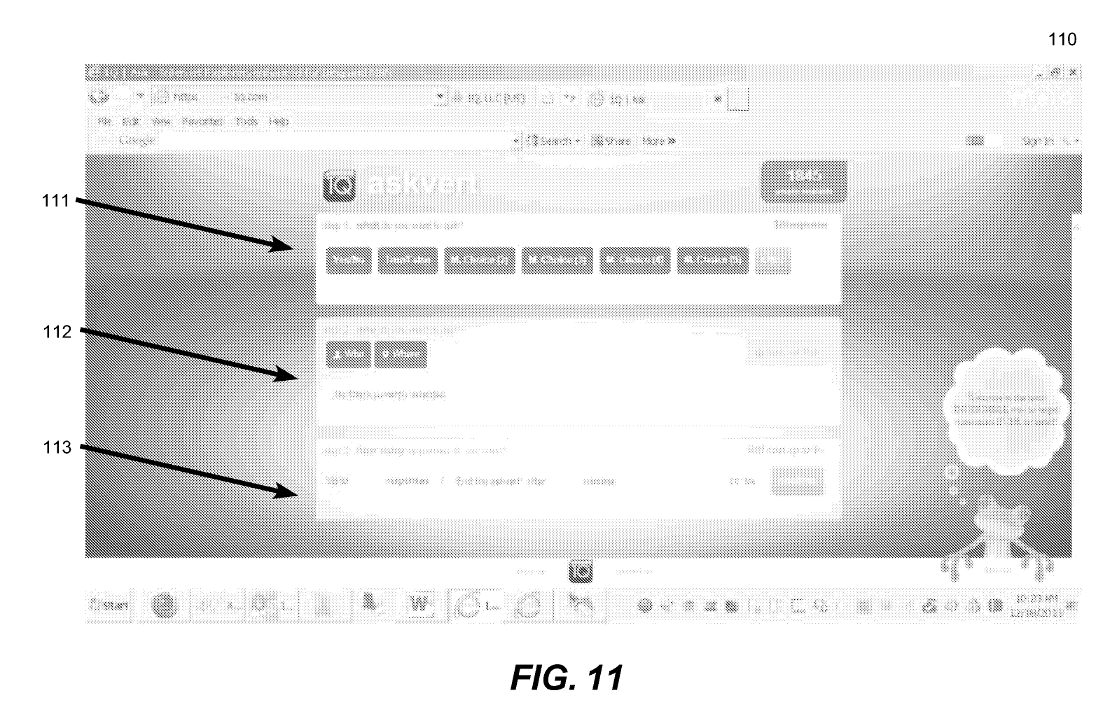

FIG. 10 depicts the user interface screen 100, which is a variation of the user interface screen 10 shown in FIG. 1, where poll designers and poll respondents enter the 1Q system with the poll designer control item 12 selected. The selected control item 12 increases in size upon selection to show the user which control item has been selected. FIGS. 11-27 illustrate additional user interface screens utilized for poll definition and result display in the 1Q system.

FIG. 11 depicts a top-level poll design panel 110 displayed by the 1Q system. The poll design panel 110 presents a simple three-step process in three panels. Panel 111 includes control items for step 1, “What do you want to ask?” Panel 112 includes control items for step 2, “Who do you want to ask?” and includes control items for “Who” and “Where” corresponding additional poll definition panels. Panel 113 includes control items for step 3, “How many responses do you want to receive?” Step 3 allows poll designers to control the cost of the poll because pole designers (1Q customers) typically for polls on a per-response basis (while 1Q members responding to polls are paid for responses on a per-response basis).

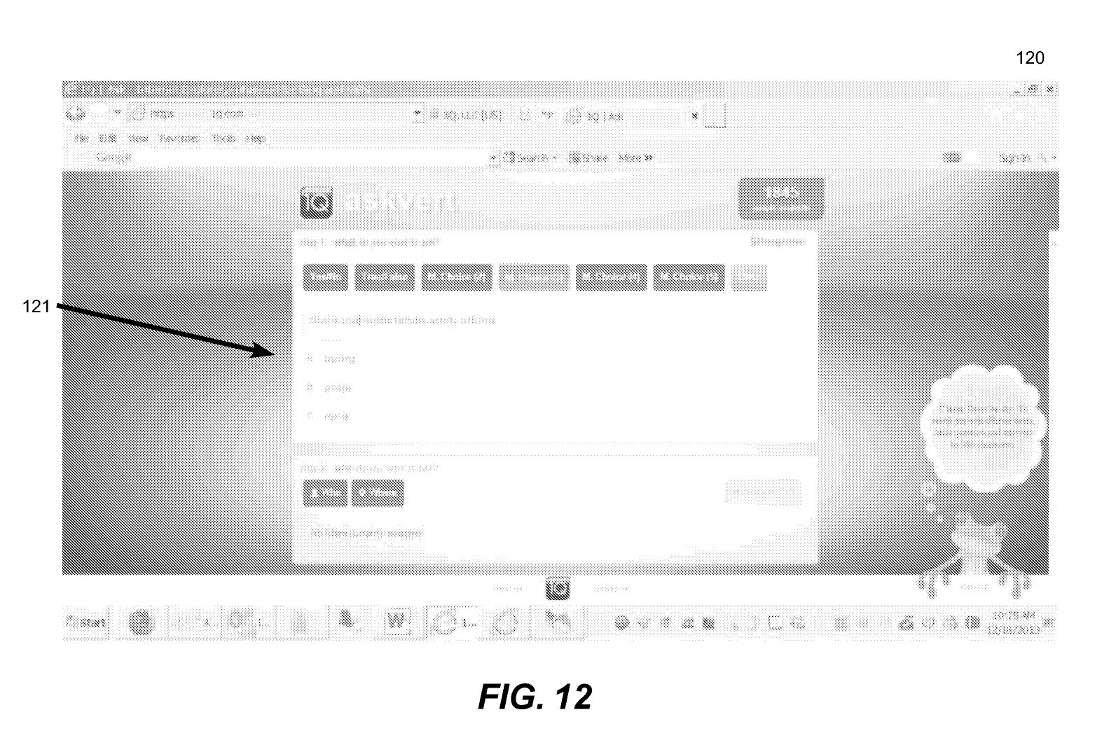

FIG. 12 depicts the poll design menu 120 displayed by the 1Q system in response to user selection of a control item for step 1, “What do you want to ask?” Panel 120 displays a poll definition panel corresponding to a poll-type selection by the user. For example, the poll-type selection includes selection items for “Yes/No”; “True/False”; “Multiple Choice (2) [i.e., a multiple choice question with two selectable choices)”; “Multiple Choice (3)”; “Multiple Choice (4)”; “Multiple Choice (5)”; and “Offer.” The specific example shows the poll definition panel for an example “Multiple Choice (3)” poll-type question, which is a semi-structured panel allowing the user to fill in the question and three answer choices in corresponding user entry fields. Appropriate semi-structured panel are displayed and receive user data into user entry fields for the other pole-type question formats.

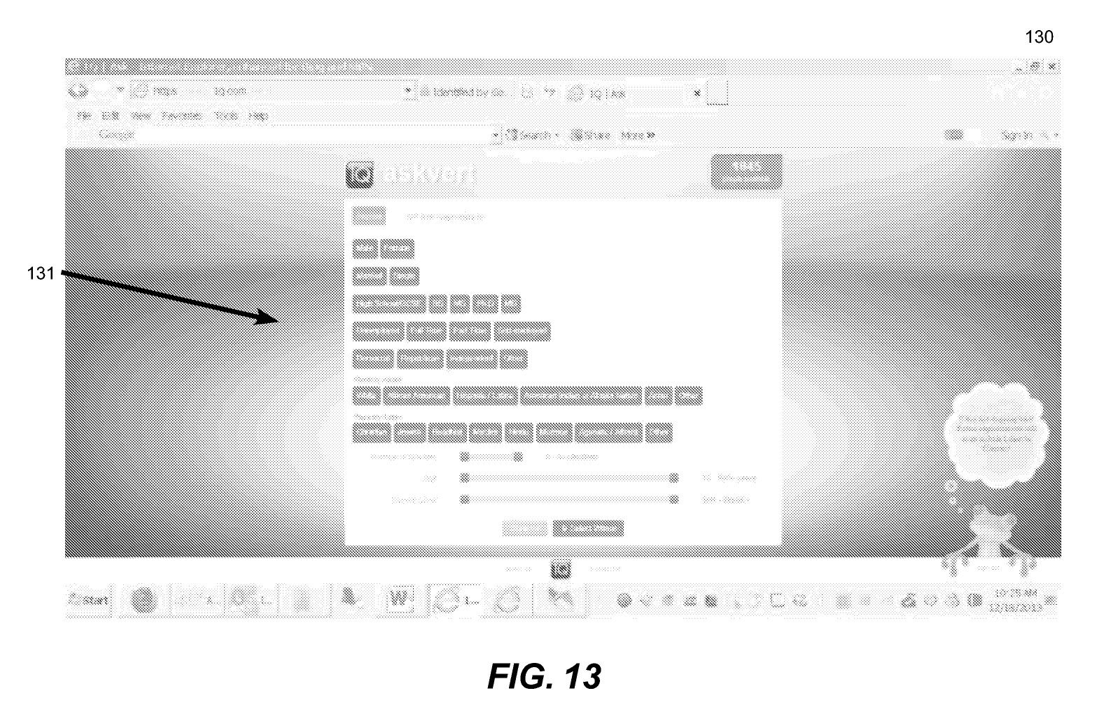

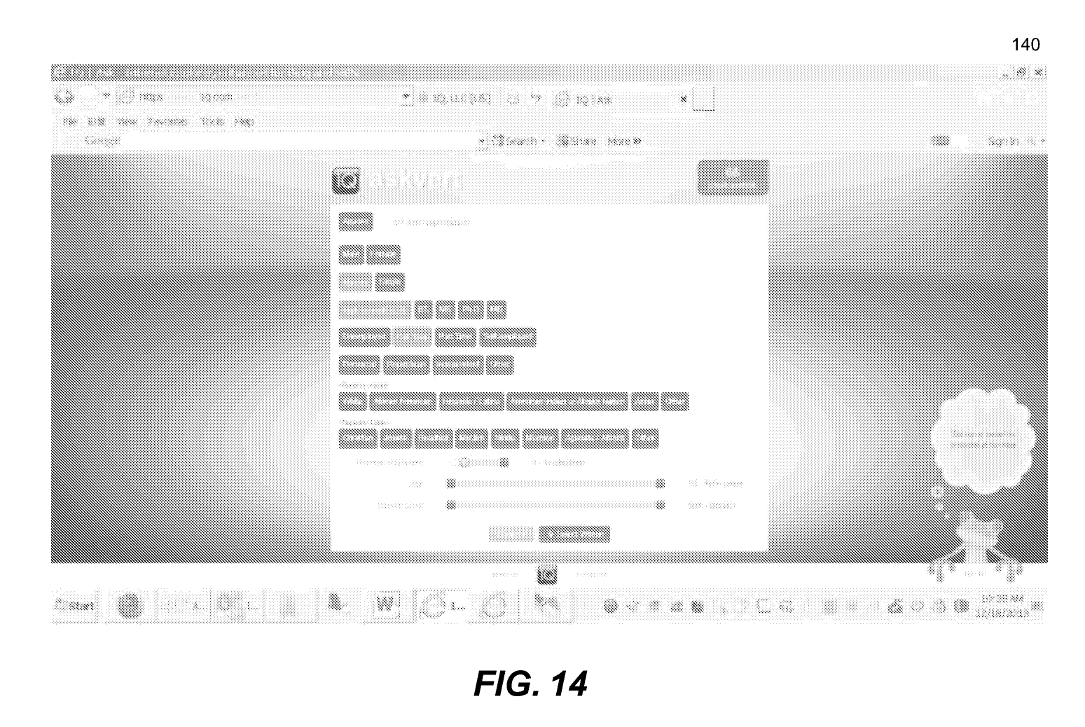

FIG. 13 depicts the poll design menu 130 displayed by the 1Q system in response to user selection of a control item for step 2, “Who do you want to ask?” In response to selection of the “Who” control item, the 1Q system displays a poll design menu 130 that includes selection items for various demographic criteria that the poll designer may select to define a desired poll audience (i.e., the demographic characteristic of respondents qualified to receive and respond to the poll question). In this particular example, the poll designer may select within a first demographic category for sex or respondent among “Male/Female”; within a second demographic category for marital status of respondent among “Married/Single”; within a third demographic category for educational level of respondent among “High School-GED/BS/MS/PhD/MD”; within a fourth demographic category for employment status of respondent among “Unemployed/Full Time/Part Time/Self Employed”; within a third fifth demographic category for political affiliation of respondent among “Democrat/Republican/Independent/Other”; within a sixth demographic category for race of respondent among “White/African American/Hispanic-Latino/American Indian or Alaska Native/Asian/Other”; and a seventh demographic category for religious affiliation of respondent among “Christian/Jewish/Budist/Muslim/Hindu/Moromon/Agnistic-Atheistic/Other”. Slider-type control items are provided for entering “Number of Children”; “Age” and “Income Level” demographic criteria. A wide range of other demographic criteria (e.g., homeowner, member of NRA, planning to purchase a new vehicle in the coming year, etc.) may be implemented with appropriate types of user controls. All of the demographic criteria selectable by the poll designers have corresponding demographic entries received from poll participants. FIG. 14 depicts the poll design menu 140 displayed by the 1Q system with certain selections entered into the respondent qualification menu.

Demographic poll featured may also be defined on an as-needed basis. For a particular poll that a customer would like to run, the 1Q system may send a targeted poll qualification question to its members asking if they are qualified for, and would like to participate in, a poll directed to a particular demographic factor. For example, a customer may desire a poll sent to parents with children less than 5 years old. 1Q supports that desired poll by sending a question to its members (potential poll participants) asking whether they are a parent with children less than 5 years old and would like to participate in a poll directed to people fitting that category. Those members who respond positively will be tagged with the demographic criterion” parent with children less than 5 years old” and qualified for that particular poll.

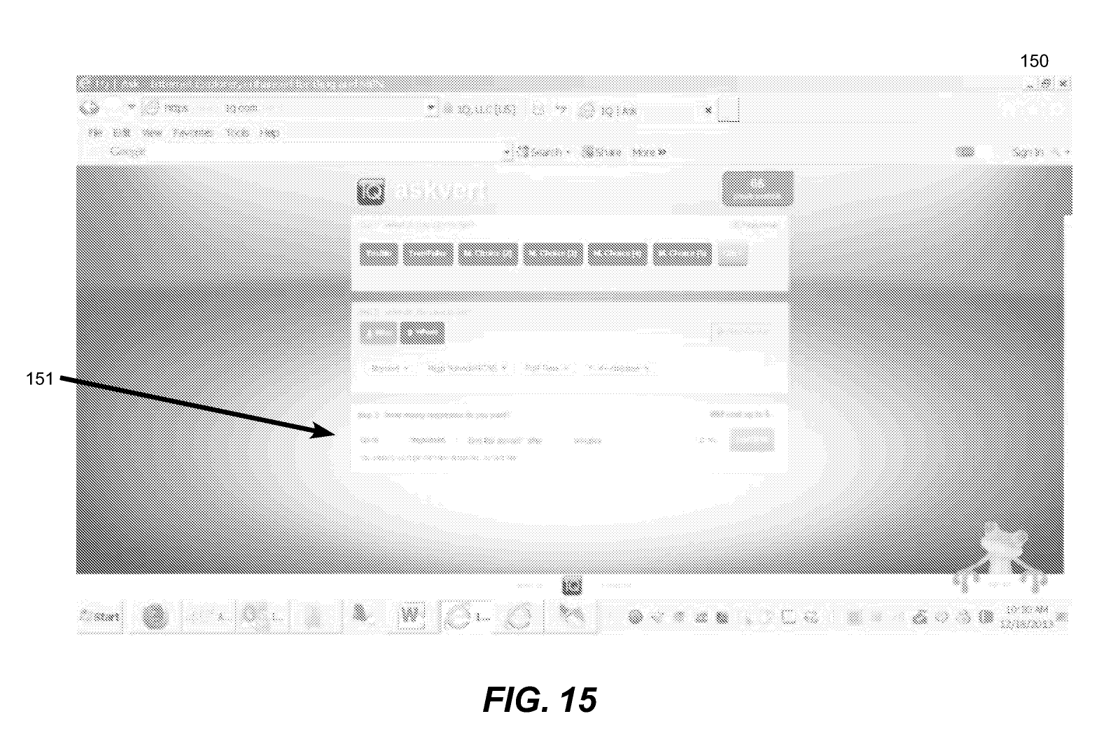

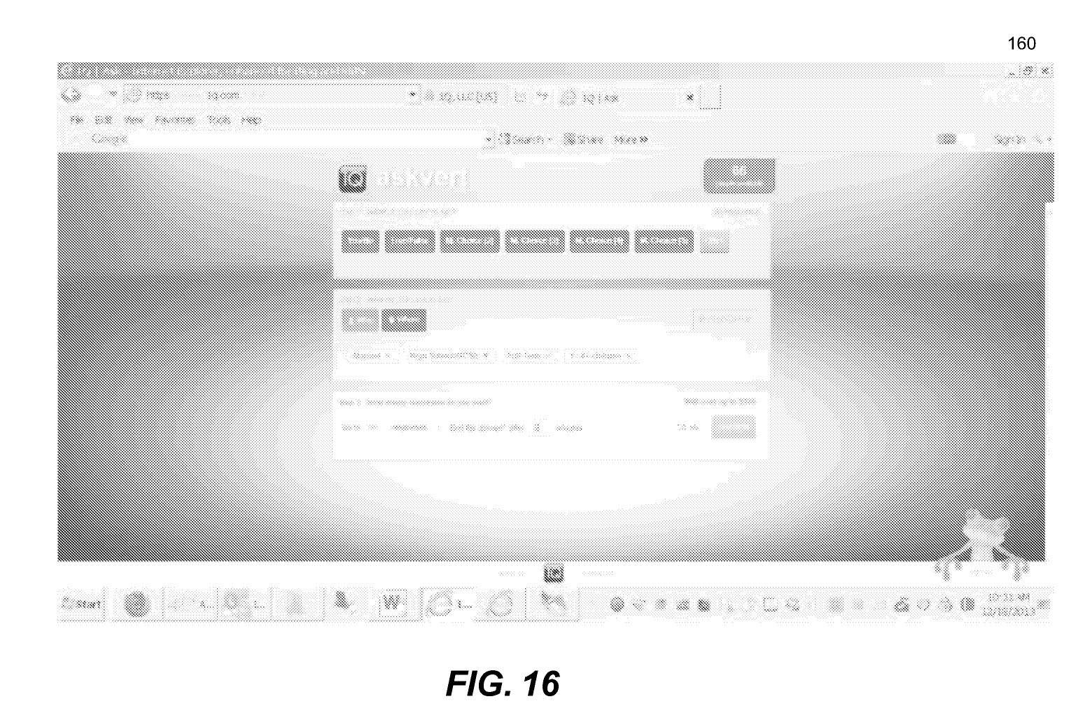

FIG. 15 depicts the poll design user interface 150 displayed by the 1Q system displayed by the 1Q system in response to user selection of a control item for step 3, “How Many Responses do you Want?” The user interface 150 is a semi-structured panel allowing the user to enter the total number of responses and a time limit for the poll. The 1Q system terminates the pole when either of the criteria are met. FIG. 16 depicts the poll design menu 160 displayed by the 1Q system with example poll ending criteria entered.

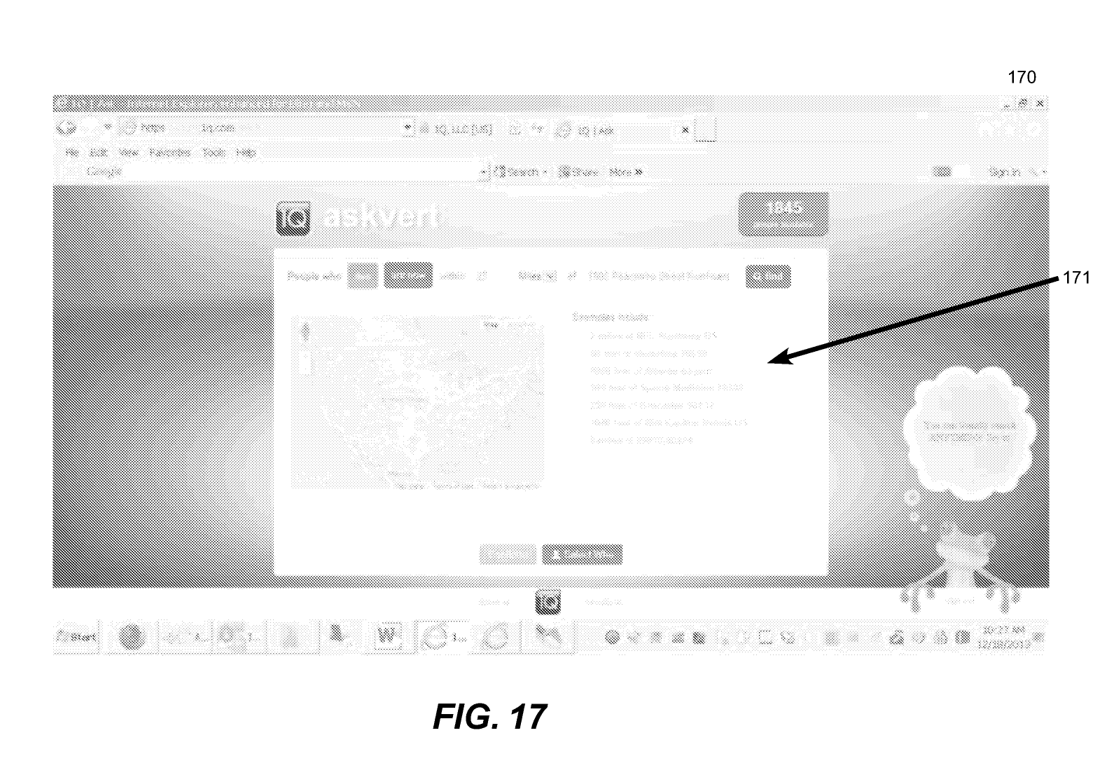

FIG. 17 depicts the poll design menu displayed by the 1Q system with a poll geographic criteria menu 160 displayed in response to selection of the “Where” control item on the poll design menu 130 under “Who do you want to ask?” The geographic criteria menu 160 is used to define the geographic scope of the pole (i.e., where poll the geographic location of the respondents must be located to be qualified to participate in the poll). This example includes a semi-structured panel 161 allowing the user to enter a distance and a location (e.g., “50 miles from “Miami Airport”; “zero miles from the state of Texas”; and “zero miles of United States”). The 1Q system also supports more sophisticated geographic definitions. A few representative examples include, “within 2 miles of NFL stadiums”; “within 2 miles of churches”; “within 8,000 feet of Atlanta Airport”; within 200 feet of grocery stores'” “within 1,000 feet of Ritz Carlton Hotels” and so forth. The selected geographic region(s) is displayed on a map that allows the user to zoom in and out as desired to view to geographic boundaries of the selected poll area.

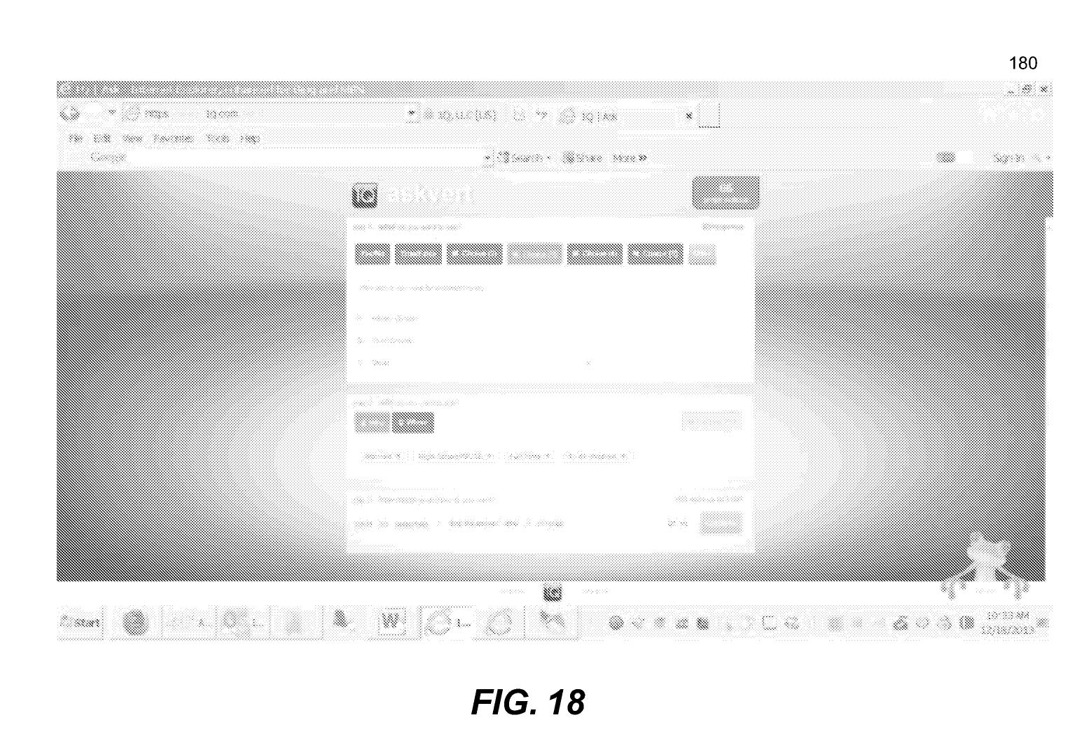

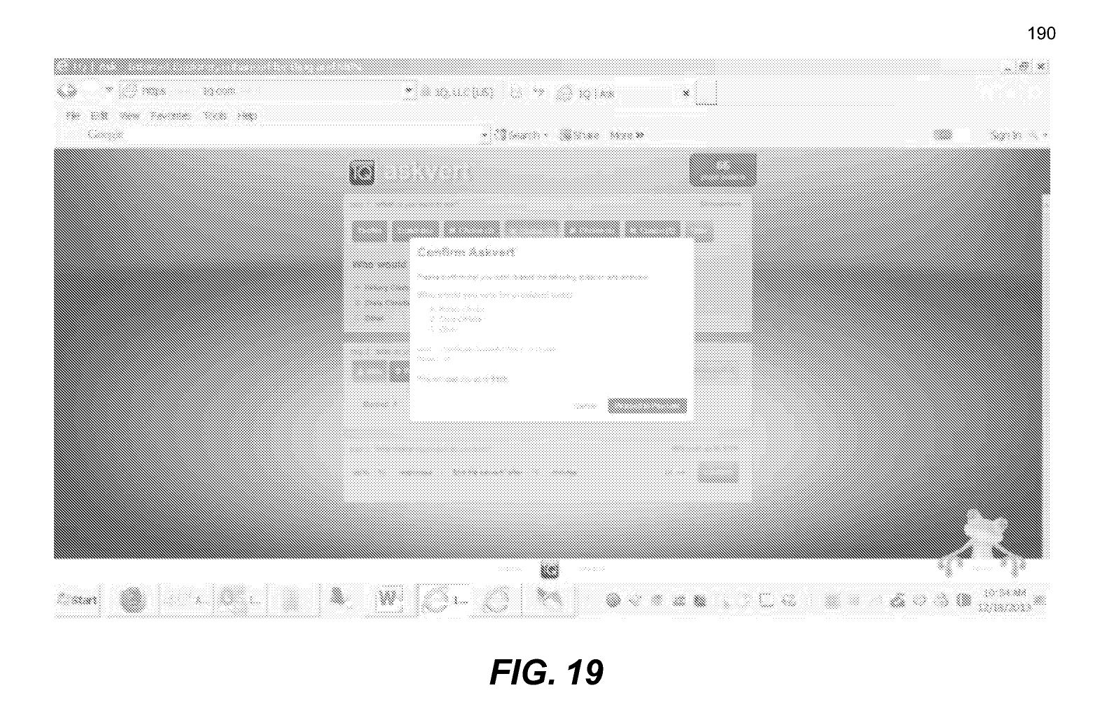

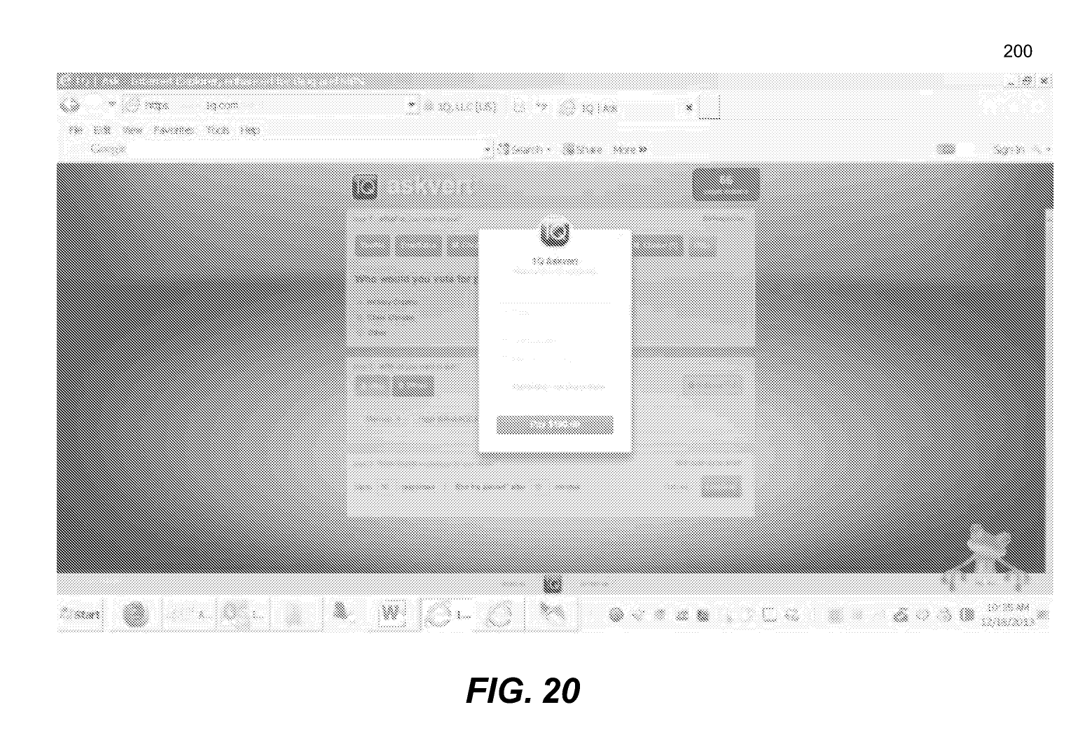

FIGS. 18-27 illustrate a poll definition and results for a specific example, which is a “Multiple Choice (3)” poll-type question. FIG. 18 depicts the poll design menu 180 displayed by the 1Q system for the example question, “Who would you vote for President Today” with answer choices “(a) Hillary Clinton”; “(b) Chris Christie” and “(c) Other”. The poll demographic criteria selected were marital status “Married”” education level “High School GED”; employment status “Full Time” and family “One to four+children”. The geographic criteria was the entire United Stated (the default setting), and the poll ending criteria were 50 responses and a time limit of five minutes. FIG. 19 depicts the poll confirmation panel 190 displayed by the 1Q system asking the poll designer to confirming the poll definition and advising the user of the maximum cost of the poll, in this example $100 (i.e., maximum 50 responses at $2 per response, of which $1 goes to the respondent and $1 goes to the 1Q system operator). Upon confirmation, the payment panel 120 shown in FIG. 20 is displayed, where the poll designer enters payment information (typically credit or credit card authorization) for the poll. Once payment authorization is received and verified, the poll is immediately launched (i.e., real-time poll initiation).

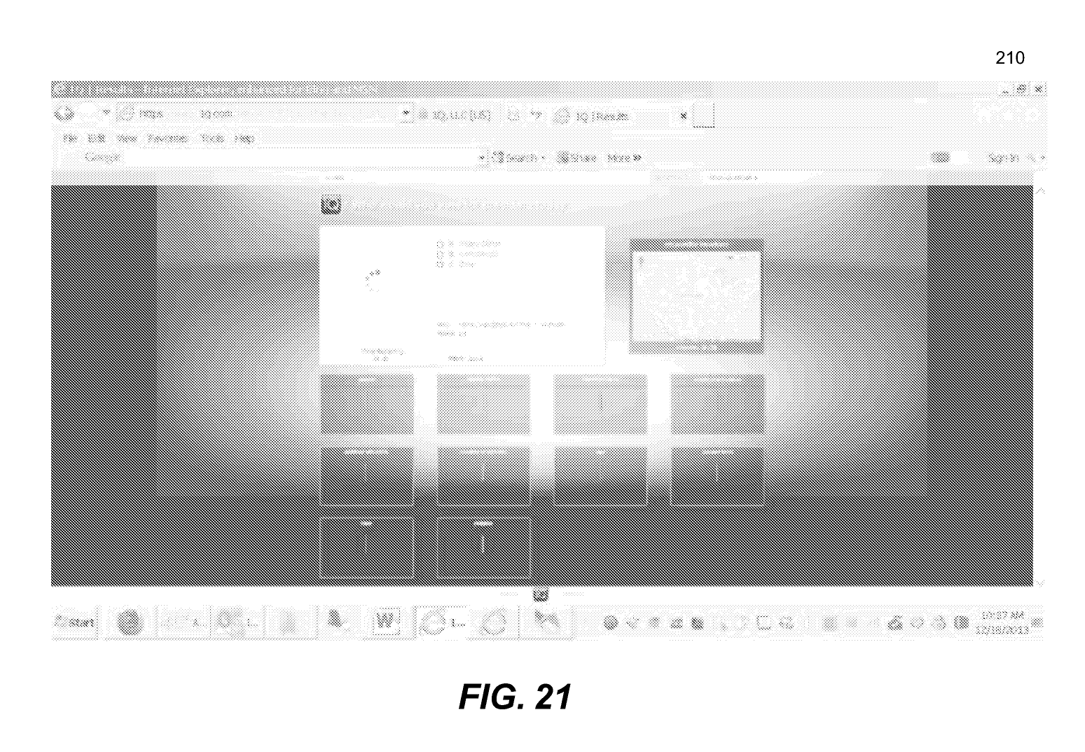

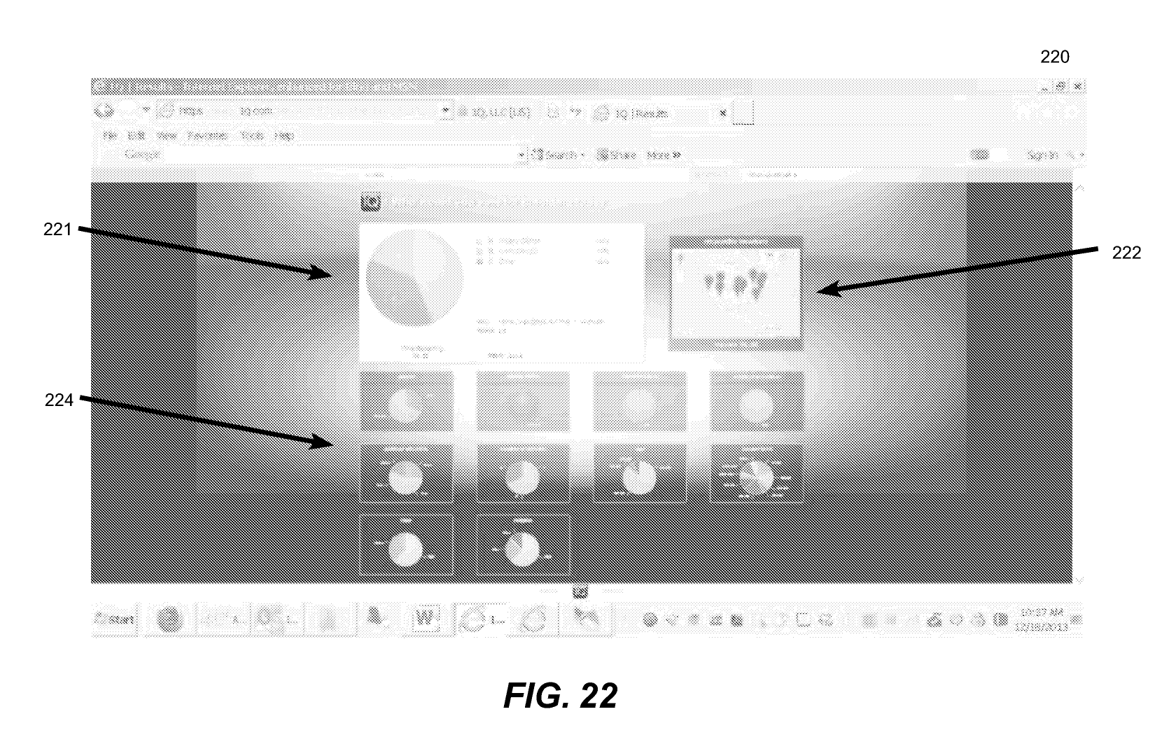

FIG. 21 depicts a dynamic in-process poll results panel 210 displayed by the 1Q system for the poll designer prior to receipt of poll results. That it, the poll results panel 210 is displayed on the poll designer's browser before any poll results are received. The poll results panel is then continually updated during the course of the poll allowing to see the results as they come in. FIG. 22 depicts a partially completed poll results panel 220 showing receipt of partial poll results while the poll is in progress. The poll results panel 220 includes a chart 221 showing the overall in-process poll results, a map of the poll geographic area with pins showing the locations of the respondents, and a series of charts showing the demographic splits for the demographic variables in the poll.

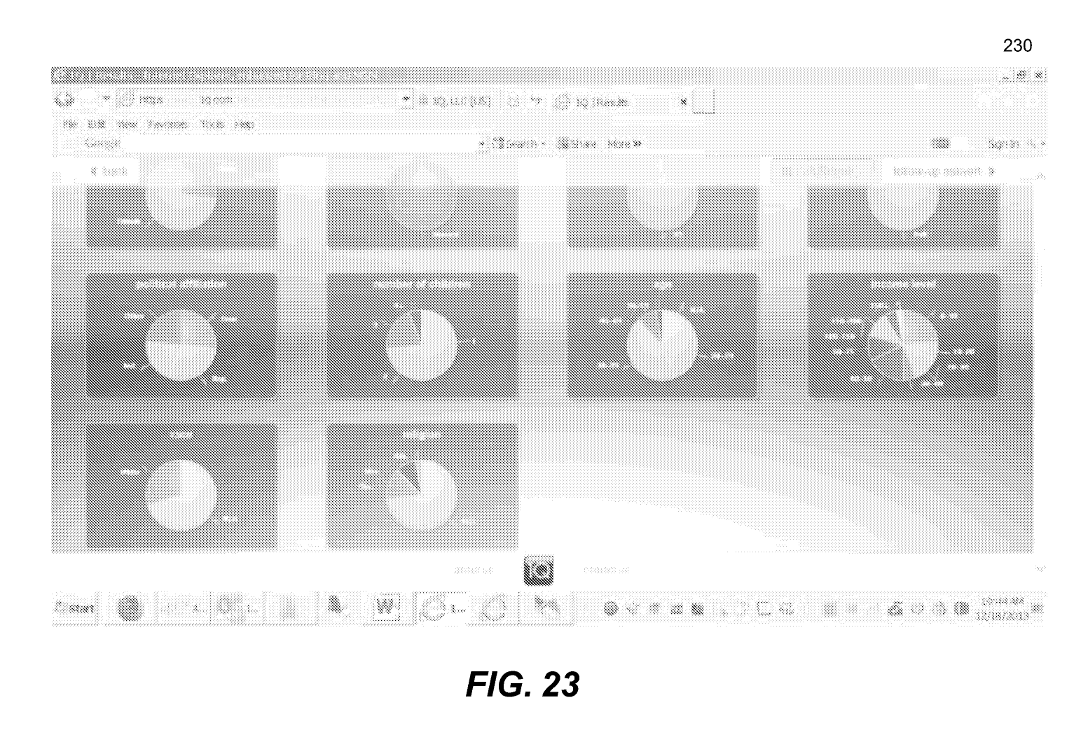

FIG. 23 depicts demographic split panels 230 displayed by the 1Q system. In this particular example, one demographic split shows the percent of responses received from “Male vs. Female” respondents; a second demographic split shows the percent of responses received for each political affiliation, and so forth. Those demographic criteria selected as poll criteria during the poll design phase show that 100% of the respondent meet the selected poll criteria. In this particular example, 100% of the respondents are married, as shown in the corresponding demographic split, because “Married” was selected as a poll criterion. Similarly, the splits for educational level show 100% “High School-GED”, and the employment split shows 100% “Full-Time” corresponding to these demographic criteria selected as poll criteria. The percent splits are shown for the other demographic categories left as variables, such “Age”; “Income Level”; “Political Affiliation” and so forth.

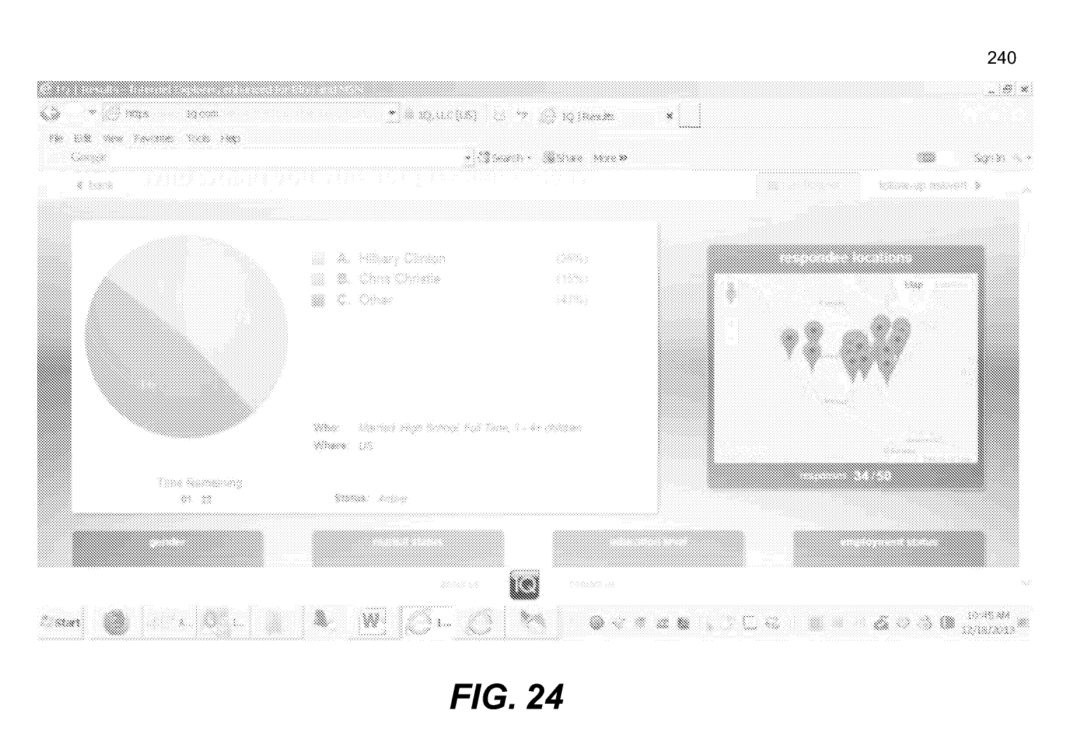

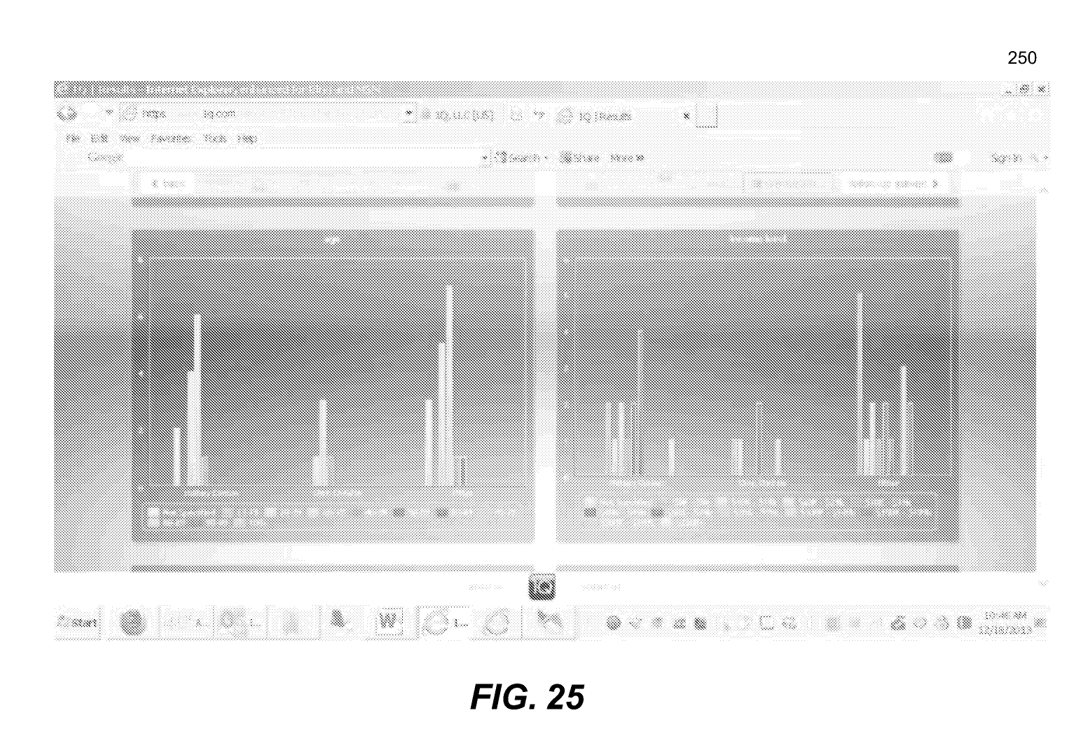

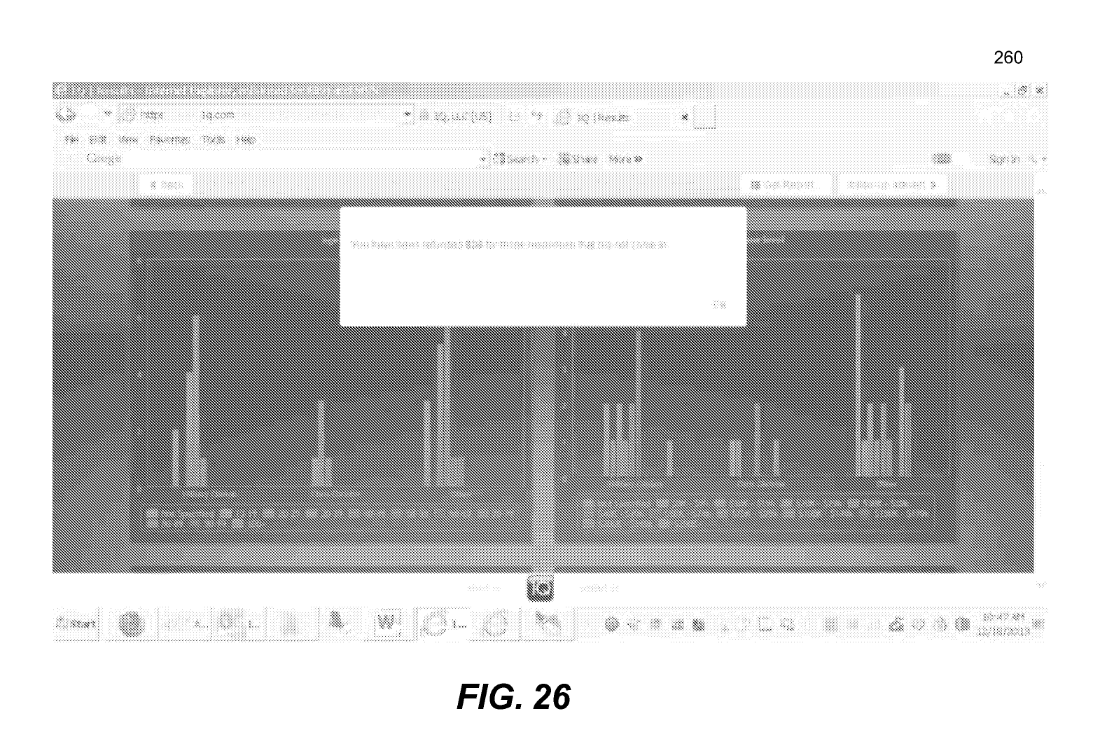

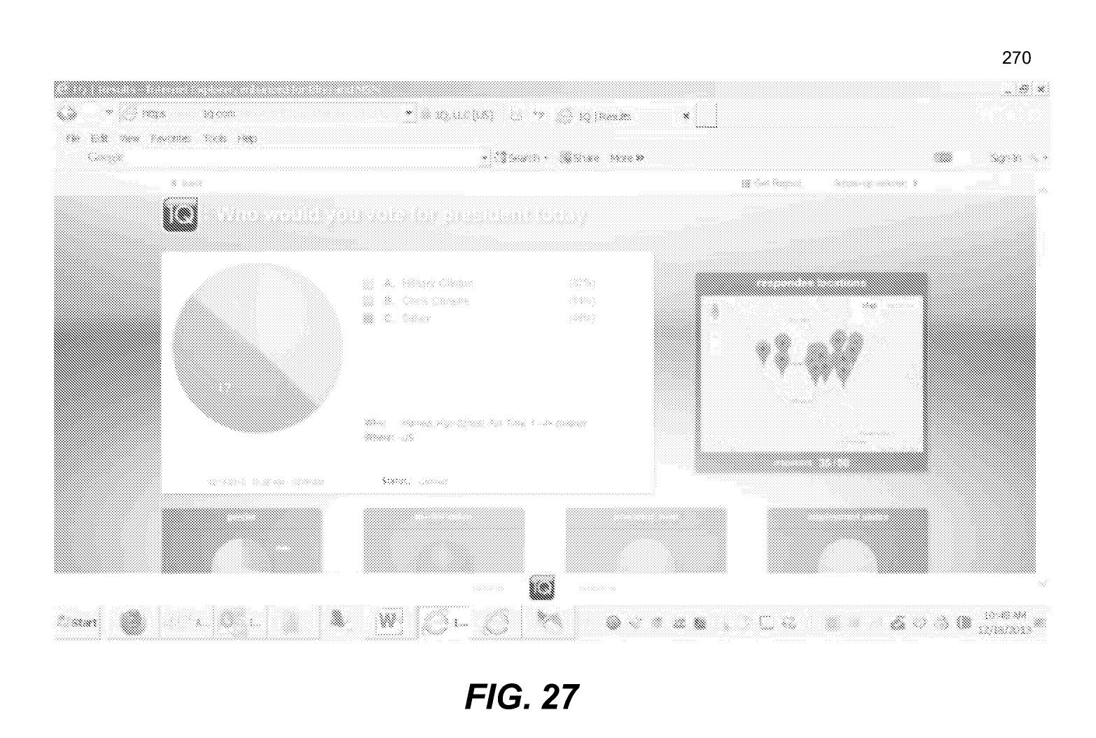

FIG. 24 depicts an enlarged view 240 of the main poll results displayed as a pie chart with a corresponding map showing the locations of the respondents. FIG. 25 depicts selected demographic split panels 250 displayed as bar charts rather than pie charts, which is a controllable feature that the 1Q system provides for user selection. FIG. 26 depicts a poll closing refund screen 260 displayed by the 1Q system because, in this particular example, the poll timed out with prior to receiving the maximum number of responses. FIG. 27 shows the completed poll results screen 270 displayed by the 1Q system upon completion of the example poll, which contain the same displayed information as the in-process poll results computed and displayed for the final poll results.

The user interface system described above allows the 1Q system to operate as an “instant response system” providing real-time poll definition, launch and response unlike any prior market pooling system. The 1Q system is permission-based through a membership system in which members agree to participate by providing short turn-around anonymous responses to electronic polling requests in exchange for per-response compensation. Customers utilize the instant response system to conduct surveys (also referred to a polls) of the members in exchange for a per-response compensation. The provider of the instant response system (“1Q system operator”) earns the difference between the fees received from the customer and the payments made to the member as compensation for operating the instant response system. For example, the customers may pay two dollars for each response received, while the members may be paid one dollar for each response provided. While other types of fees and payments may be utilized, the per-response compensation model is easy to understand and has been found to be highly effective in motivating participation by both members and customers on a basis that is transparent and easily measured and tracked by all involved.

In order to participate in the compensation system, each member enters into a marketing participation agreement and provides the 1Q system operator with demographic information about the member, such as age, address, education, family, income, purchasing preferences, and so forth. The member is encouraged to provide greater levels of demographic data to increase the likelihood they will be selected to participate in surveys. While membership questionnaires may run the range from basic to highly involved, the 1Q system may only request a bare minimum of information, such as the member's name and phone number, along with authorization to obtain additional member profile information from their social media resources, such as Facebook. Members may also authorize 1Q to access and utilize information about the member from public resources, such as Equifax. Members are encouraged to enter advanced demographic information into their social media resources and may, for example, create a “1Q” section specifically designed to contain member supplied information intending that information to be used by 1Q to determine their suitability and desire to be in surveys relating to different areas of potential inquiry.

Advanced demographics may include information such as professional information, areas of professional interest, areas of recreational interest, areas of expertise, hobbies, family information, political affiliations, associations, automobiles, vacation locations, preferred reading materials, major products or services recently purchased, major products or services they intend to purchase in the near future, health information, etc. While 1Q will keep all the member's profile information and survey responses strictly confidential, all of this demographic information as well as their prior survey response history can be used to target the member for survey participation. Members are therefore motivated to provide higher levels of demographic information to increase the likelihood that they will be selected for polling based on the demographic data provided. The demographic data is contained in a member profile stored as part of the instant response system, where is can be used to target the member as a survey recipient. In this manner, the instant response system accumulates a great deal of demographic information about its members while simultaneously obtaining authorization to use this information for customer surveys and market research purposes.

Members are also encouraged to allow the 1Q system operators to automatically post whenever the member receives compensation from 1Q on their social media resource. Although the fact of compensation is considered to be an effective posting, additional compensation related information may be automatically posted if desired, such as the amount of compensation, the number of surveys, the duration of membership, and so forth. Members may also authorize advanced features such as “friend tracking” and “location tracking” so that the number of friends on their site and their geographical location may be used as survey selection criteria. The member may also authorize a survey compensation “hot link” to the instant response system where the amount of survey compensation paid to the member is continually updated by the instant response system. Posting the fact of the member's participation in the 1Q system and member's survey compensation on social media provides effective advertising for the 1Q system provider motivating others to join as members. These and other social media factors can be tracked and used as ranking parameters to increase the member's priority as a potential survey recipient, thereby increasing the member's income potential through survey participation.

The 1Q system utilizes a dynamic polling algorithm that allows the 1Q survey results to satisfy survey constraints and very closely match target demographics defined by a survey request with a minimal number of survey responses. The survey constraints and target demographics provided by the customers as part of the survey request are typically obtained from actual demographic resources. The 1Q dynamic polling algorithm allows the survey to “hone in” on the desired demographic results with a minimal number of survey requests by submitting the requests to members forming the target audience in a priority order, computing the residual target demographics as survey results roll in, and continually adjusting the target audience to match the residual target demographics as the survey progresses. This allows the 1Q system to iteratively narrow the target audience to those members having the increasingly precise demographics needed to meet the target demographics as the survey progresses toward completion.

While dynamically converging on the target demographics as described above, the 1Q system ranks the members in a priority order for inclusion in the poll using a number of weighting factors that take a number of factors into consideration in the weighting process. The weighting factors include a number of “system factors” that are considered beneficial to the 1Q system operator by encouraging membership growth and participation, along with a number of “customer factors” that are considered beneficial to completion of the survey with a minimum of requests by closely matching the target audience to the residual target demographics. The weighting is progressively shifted from system factors to customer factors as the survey progresses to meet both sets of objectives while fulfilling the survey request with a minimum number of survey requests.

The 1Q system may produce categorized surveys with multivariate relationships. Every poll specifies a number of demographic categories with defined criteria. To provide a simple example, a particular survey may specify age, geographic region, and ethnic race as demographic categories, with each category defining four criteria. A poll without multivariate relationships requires only that the overall survey results meet these demographic criteria. Multivariate relationships, on the other hand, specify the demographic results for the criteria within each category. Expanding the preceding example into a multivariate example, each “age” category has its own demographic complex of geography and race factors, each “geography” category has its own demographic complex of age and race factors, and each “rage” category has its own demographic complex of age and race factors.

Conducting a poll to closely match target demographics with multivartiate relationships is extremely challenging because the interrelating criteria result in a giant jigsaw puzzle requiring, for example, 5000 surveys to obtain the “right” 1000 responses that match the multivartiate relationships of the target demographics. There are no polling systems currently available that are designed to produce poll results that closely match target demographics with multivartiate relationships. To meet this challenge, the 1Q system includes a dynamic polling algorithm that matches target demographics with multivartiate relationships within a defined margin of error, or presents the best available results, though the dynamic polling procedure. For example, the 1Q system may alert the customer, and provide the best available response, when the member database is simply not large enough to precisely match the multivariate demographic makeup of a national poll for a country of interest within the desired margin of error. In addition, the 1Q system may alert the customer, and provide the best available response, when an attempt to converge on a specific multivariate demographic makeup, within a specific margin of error, reaches a specified maximum survey time or number or responses.

It will be appreciated that the foregoing describes an improved online market research and polling systems and, more specifically, market research and polling systems with user interfaces that are easier to use and understand. It will be further understood that the foregoing describes a preferred embodiment of the invention and that many adjustments and alterations will be apparent to those skilled in the art within the spirit and scope of the invention as defined by the appended claims.

The invention claimed is:

1. A dynamic permission-based market polling and research system, comprising:
a menu-driven respondent registration utility configured to receive demographic information from users registering as poll respondents;
the respondent registration utility further configured to compute and display an earning potential indicator that increases with increasing demographic information received from a registering user to encourage the registering user to enter complete demographic information; and
the market polling and research system configured to use the demographic information to qualify registered respondents to participate in polls in exchange for poll response compensation.

2. The market polling and research system of claim 1, wherein the poll response compensation is paid on a per-response basis.

3. The market polling and research system of claim 1, wherein the menu-driven respondent registration utility further comprises:
a menu-driven respondent designation utility operable for receiving a designation of a charitable organization to receive a designating respondent's poll response compensation; and
the market polling and research system configured to pay the designating respondent's poll response compensation to the designated charitable organization.

4. The market polling and research system of claim 3, wherein the menu-driven respondent designation utility further comprises a charitable organization selection menu displaying a predefined list of charitable organizations allowing the designation to be entered by selection from the list.

5. The market polling and research system of claim 1, wherein the menu-driven respondent registration utility further comprises a verification code utility configured to:
send a verification code to a registering respondent by a communication mode separate from the menu-driven respondent registration utility;
receive the verification code entered into the verification code utility; and
complete registration of the registering respondent upon receipt of the verification code into the verification code utility.

6. The market polling and research system of claim 1, further comprising a downloadable mobile app configured to allow registered respondents to receive poll questions and submit poll responses from mobile communication devices.

7. A dynamic permission-based market polling and research system, comprising:
a menu-driven poll definition utility configured to receive poll definitions from poll designers;
the market polling and research system configured to communicate polls in accordance with the poll definitions to a plurality of registered respondents, receives poll responses, and display the poll responses; and
the poll definition utility comprising a top-level panel displaying control items corresponding to a three-step process for designing a poll.

8. The market polling and research system of claim 7, wherein the control items corresponding to the three-step process include:
a first poll definition panel for defining a poll question;
a second poll definition panel for defining demographic criteria of qualified respondents; and
a third poll definition panel for defining ending criteria for the poll.

9. The market polling and research system of claim 8, wherein:
the first poll definition panel for defining a poll question includes control items for selecting among a plurality of predefined question formats; and
upon user selection of a question format, expands to display a semi-structured panel receiving user entry defining contents of a poll question in the selected question format.

10. The market polling and research system of claim 8, wherein:
the second poll definition panel for defining a poll question includes a first control item for selecting a demographic definition of qualified poll recipients and a second control item for selecting a geographic definition for the poll.

11. The market polling and research system of claim 8, wherein the third poll definition panel includes a semi-structured panel for entering a maximum number of poll responses and a maximum poll time.

12. A dynamic permission-based market polling and research system, comprising an in-process poll result reporting utility configured to compute, display and continually update in-process poll results as a poll progresses, wherein the in-process poll results comprise:
a chart depicting overall poll results; and
a map indicating locations of poll results.

13. The market polling and research system of claim 12, wherein the continually updated in-process poll results further comprise one or more demographic split charts depicting percentages of poll results received by respondents in demographic categories.

14. The market polling and research system of claim 12, further comprising a completed poll result reporting utility configured to compute and display final poll results comprising:
a chart depicting overall poll results; and
a map indicating locations of poll results.

15. The market polling and research system of claim 14, wherein the final poll results further comprise one or more demographic split charts depicting percentages of poll results received by respondents in demographic categories.

16. A method for conducting online polls, comprising:
displaying a menu-driven respondent registration utility configured to receive demographic information from users registering as poll respondents and display an earning potential indicator that increases with increasing demographic information received from a registering user to encourage the registering user to enter complete demographic information;
registering a plurality of poll respondents through the respondent registration utility;
displaying a menu-driven poll definition utility configured to receive poll definitions from a poll designer including a first poll definition panel for defining a poll question, a second poll definition panel for defining demographic criteria of qualified respondents, and a third poll definition panel for defining ending criteria for the poll;
receiving a poll definition through the menu-driven poll definition utility;
determining a group of qualified poll respondents corresponding to the poll definition;
transmitting the poll question to the group of qualified poll respondents;
receiving responses to the poll question from a plurality of the qualified poll respondents;
displaying and continually updating in-process poll results including at least a chart depicting overall poll results and a map indicating locations of poll results while the poll is in progress;
ending the poll in response to determining that determining that at least one of the ending criteria for the poll have been met;
displaying final poll results including at least a chart depicting overall poll results and a map indicating locations of poll results after the poll has ended.

17. The method of claim 16, further comprising computing, continually updating and displaying in-process poll results including one or more demographic split charts depicting percentages of poll results received by respondents in demographic categories.

18. The method of claim 16, further comprising computing and displaying final poll results including one or more demographic split charts depicting percentages of poll results received by respondents in demographic categories.

19. A computer storage medium storing non-transitory computer-readable instruction for causing a computer to perform a method comprising:
displaying a menu-driven respondent registration utility configured to receive demographic information from users registering as poll respondents and display an earning potential indicator that increases with increasing demographic information received from a registering user to encourage the registering user to enter complete demographic information;
registering a plurality of poll respondents through the respondent registration utility;
displaying a menu-driven poll definition utility configured to receive poll definitions from a poll designer including a first poll definition panel for defining a poll question, a second poll definition panel for defining demographic criteria of qualified respondents, and a third poll definition panel for defining ending criteria for the poll;
receiving a poll definition through the menu-driven poll definition utility;
determining a group of qualified poll respondents corresponding to the poll definition;
transmitting the poll question to the group of qualified poll respondents;
receiving responses to the poll question from a plurality of the qualified poll respondents;
displaying and continually updating in-process poll results including at least a chart depicting overall poll results and a map indicating locations of poll results while the poll is in progress;
ending the poll in response to determining that determining that at least one of the ending criteria for the poll have been met;
displaying final poll results including at least a chart depicting overall poll results and a map indicating locations of poll results after the poll has ended.

20. The computer storage medium of claim 19, wherein the method further comprises:
computing, continually updating and displaying in-process poll results including one or more demographic split charts depicting percentages of poll results received by respondents in demographic categories; and
computing and displaying final poll results including one or more demographic split charts depicting percentages of poll results received by respondents in demographic categories.
